(19) United States
(12) Patent Application Publication
(10) Pub. No.: US 2008/0009190 A1
(43) Pub. Date: Jan. 10, 2008

(54) CONNECTOR

(75) Inventors: I-Hsien Liu, Hsinchu (TW); Tzu-Tse Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/746,065

(22) Filed: May 9, 2007

(30) Foreign Application Priority Data
Jul. 5, 2006 (TW) 95124442

(51) Int. Cl. H01R 13/658

(52) U.S. Cl. 439/607

(57) ABSTRACT

A connector suitable for an electronic apparatus is provided. The connector includes multiple connection ports, a transmission part, and an aluminum-foil cover. The transmission part is electrically connected to the connection ports. The aluminum-foil cover comprises a first surface, a second surface, and glue. The first surface and the second surface are opposite to each other. The second surface faces towards the transmission part. The glue is disposed on the second surface. The aluminum-foil cover is stuck on the surface of the transmission part by means of the glue, such that the aluminum-foil cover covers the transmission part.

### CROSS-REFERENCE TO RELATED APPLICATION

This application claims the priority benefit of Taiwan application serial no. 95124442, filed Jul. 5, 2006. All disclosure of the Taiwan application is incorporated herein by reference.

### BACKGROUND OF THE INVENTION

1. Field of Invention

The present invention relates to a connector. More particularly, the present invention relates to a connector with an EMI (electromagnetic interference)-shielding component.

2. Description of Related Art

Connectors are of great importance in various electronic apparatuses and serve as media for transmitting electrical signals between electronic apparatuses and external apparatuses. However, an electronic apparatus usually comprises a plurality of devices which generate electromagnetic waves of different frequencies, and the electromagnetic waves interfere in electrical signals transmitted by a connector. Therefore, a connector usually has an EMI-shielding component.

Referring to FIG. 1, a conventional connector 100 is applicable for an optical projector A1 and comprises two connection ports 110, a transmission part 120, and an EMI-shielding casing 130. The connector 100 is a video graphics array connector (VGA connector). Additionally, the EMI-shielding casing 130 undergoes a process of machining to be shaped in advance and then fixed on the periphery of the transmission part 120 via a snap 132 or by means of welding.

When the optical projector A1 is operating, a plurality of different power supply modules (not shown) inside the optical projector A1 generates electromagnetic waves of different frequencies. At this point, the EMI-shielding casing 130 prevents a part of the electromagnetic waves from interfering in the signals output by the connector 110. However, the manufacture of the EMI-shielding casing 130 of the conventional connector 100 is quite complicated and the manufacturing cost is high.

### SUMMARY OF THE INVENTION

Accordingly, one objective of the present invention is to provide a connector, which has an EMI-shielding structure manufactured through a simple process and a low cost.

In order to achieve the aforementioned or another objective, the present invention provides a connector applicable for an electronic apparatus. The connector comprises a plurality of connection ports, a transmission part, and an aluminum-foil cover. The transmission part is electrically connected to the connection ports. The aluminum-foil cover has a first surface, a second surface, and glue, wherein the first surface and the second surface are opposite to each other and the second surface faces towards the transmission part. The glue is disposed on the second surface. The aluminum-foil cover is stuck on the surface of the transmission part by means of the glue, such that the aluminum-foil cover covers the transmission part.

Based upon the above, since the aluminum-foil cover of the present invention is shaped through buckling the aluminum-foil plate and then sticking it on the surface of the transmission part, instead of undergoing the process of machining, the manufacturing method of the aluminum-foil cover disclosed by the present invention is simple and the manufacturing cost is low.

In order to the make aforementioned and other objects, features and advantages of the present invention comprehensible, a preferred embodiment accompanied with figures are described in detail below.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a conventional connector.

FIG. 2 is a perspective view of the connector according to one embodiment of the present invention.

FIG. 3 is a perspective view of the aluminum-foil cover in FIG. 2.

FIG. 4A is a frame shown when the connector without the aluminum-foil cover in FIG. 2 transmits a video signal.

FIG. 4B is a frame shown when the connector with the aluminum-foil cover in FIG. 2 transmits a video signal.

FIGS. 5A-5H are schematic views of the steps of assembling the aluminum-foil cover according to one embodiment of the present invention.

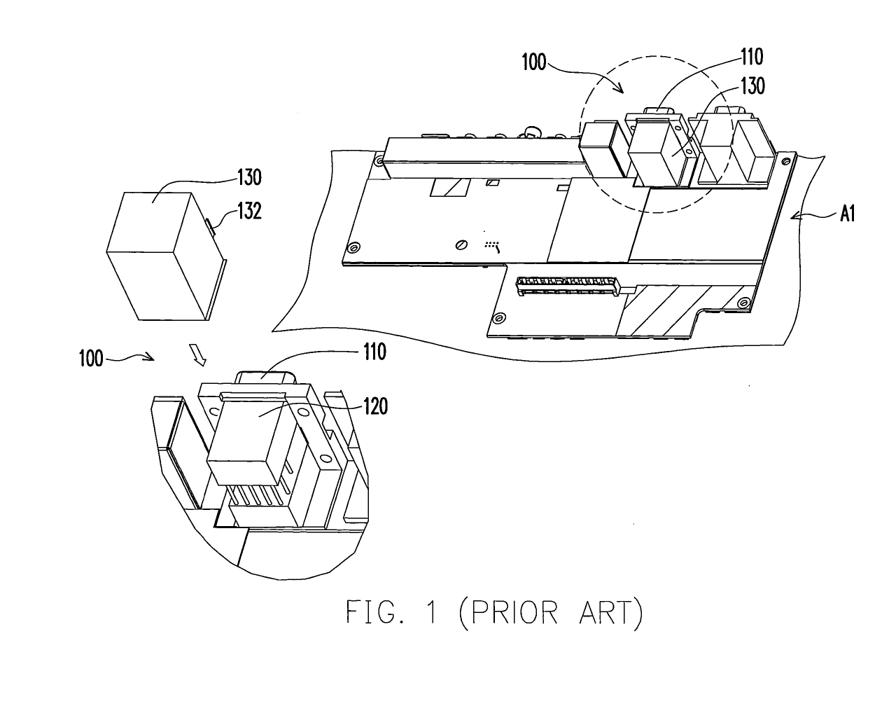

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

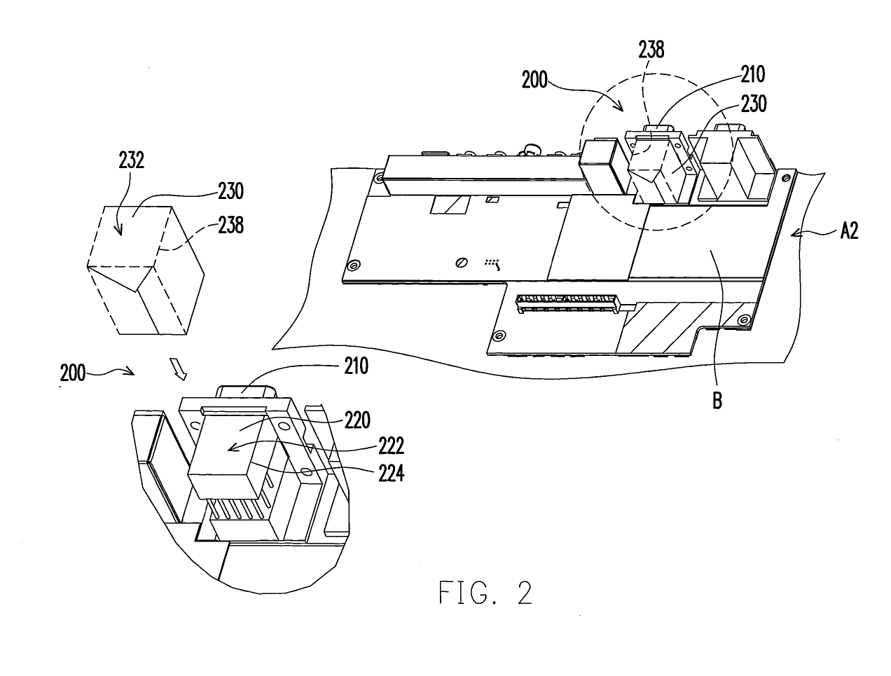

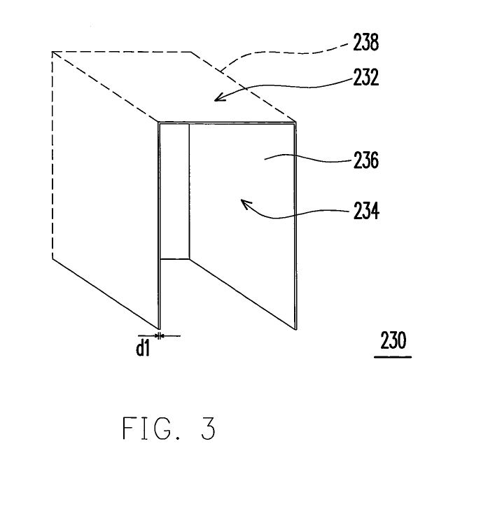

Referring to FIGS. 2 and 3, a connector 200 of the present embodiment is suitable for an electronic apparatus A2, such as an optical projector. The connector 200 comprises a plurality of connection ports 210, a transmission part 220, and an aluminum-foil cover 230. The connection ports 210 may be video graphics array connection ports (VGA connection ports). The transmission part 200 is electrically connected between the connection ports 210 and a circuit board B. When the connection ports 210 are connected to an external electronic apparatus (not shown), the transmission part 220 is responsible for transmitting signals between the connection ports 210 and the circuit board B.

The aluminum-foil cover 230 comprises a first surface 232, a second surface 234, and a glue 236. The second surface 234 faces towards the transmission part 220, and the glue 236 is disposed on the second surface 234. The aluminum-foil cover 230 is stuck on the surface 222 of the transmission part 220 by means of the glue 236, such that the aluminum-foil cover 230 covers the transmission part 220. When the electronic apparatus A2 is operating, a plurality of different power supply modules (not shown) inside the electronic apparatus A2 generates electromagnetic waves of different frequencies. At this point, the aluminum-foil cover 230 prevents a part of the electromagnetic waves from interfering in the signals output by the connector 200.

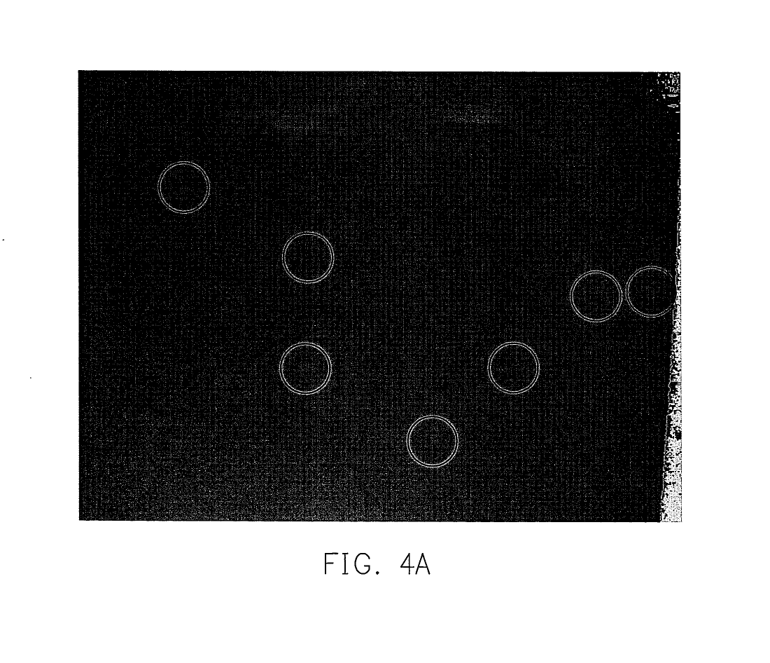

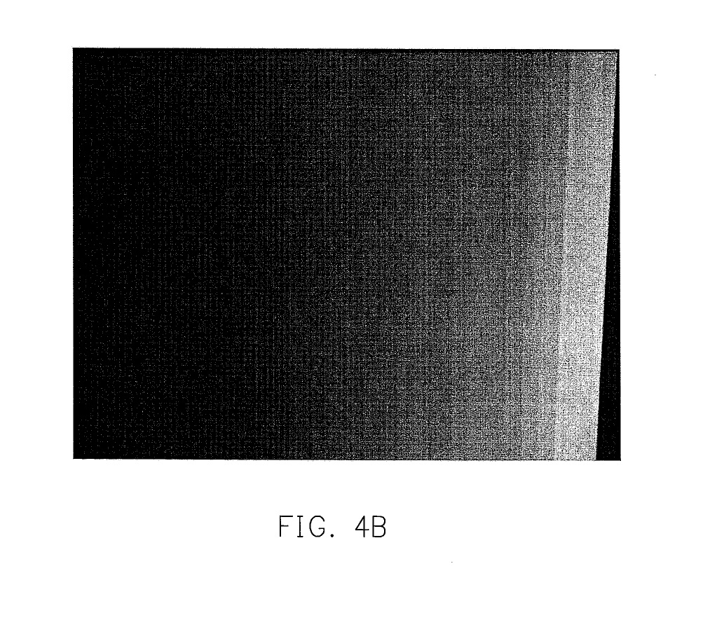

Referring to FIGS. 4A and 4B, FIG. 4A is a frame shown when the connector without the aluminum-foil cover in FIG. 2 transmits a video signal, and FIG. 4B is a frame shown when the connector with the aluminum-foil cover in FIG. 2 transmits a video signal. It should be noted here that, in order to make clear marks, bright spots in the frame shown by FIG. 4A are selected and marked by means of circling. Upon comparing the frame shown in FIG. 4A with the frame shown in FIG. 4B, the frame shown when the connector 200 with the aluminum-foil cover 230 transmits the video signal has less bright spots and noise.

In the present embodiment, the thickness d1 of the aluminum-foil cover 230 is smaller than or equal to 0.1 mm, and the aluminum-foil cover 230 comprises at least one auxiliary line 238 disposed on the first surface 232 of the aluminum-foil cover 230. The auxiliary line 238 is correspondingly aligned with one of the plurality of edges 224 of the transmission part 220. When the aluminum-foil cover 230 is to be stuck on the surface 222 of the transmission part 220, the auxiliary line 238 becomes a reference for aligning the aluminum-foil cover 230 with one of the edges 224 of the transmission part 220.

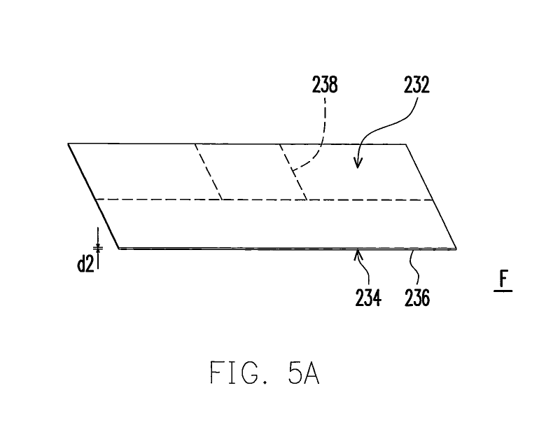

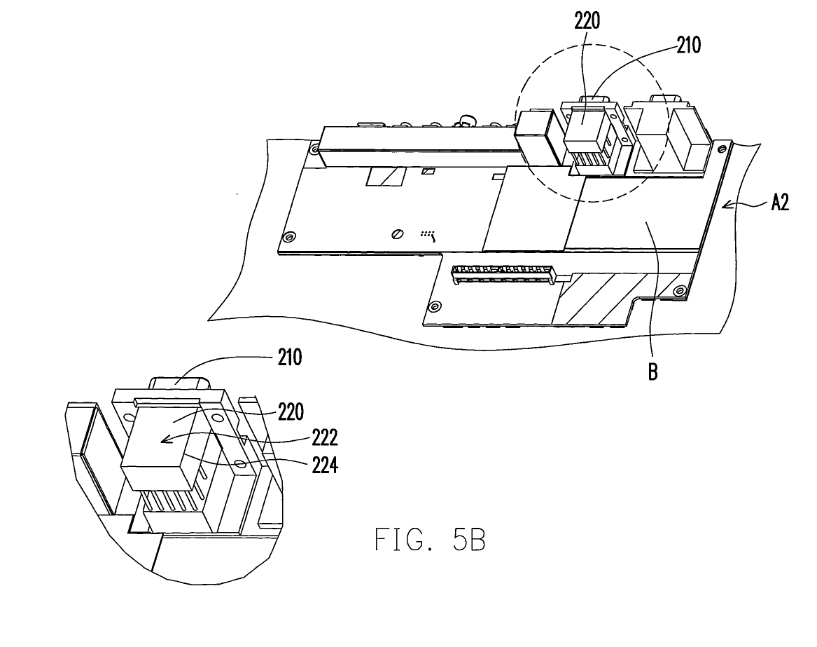

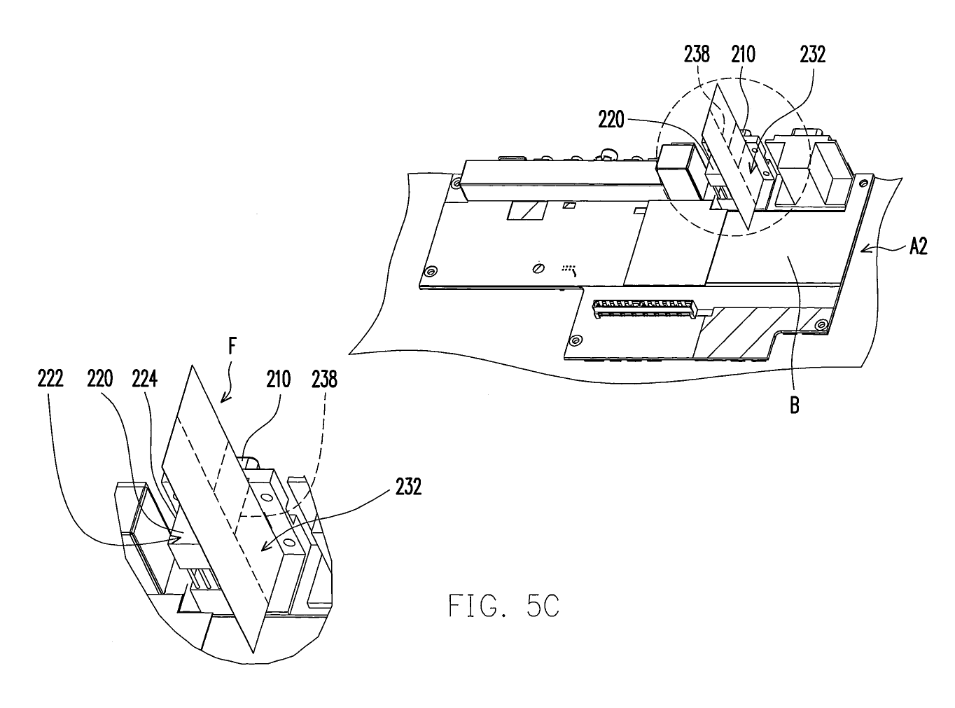

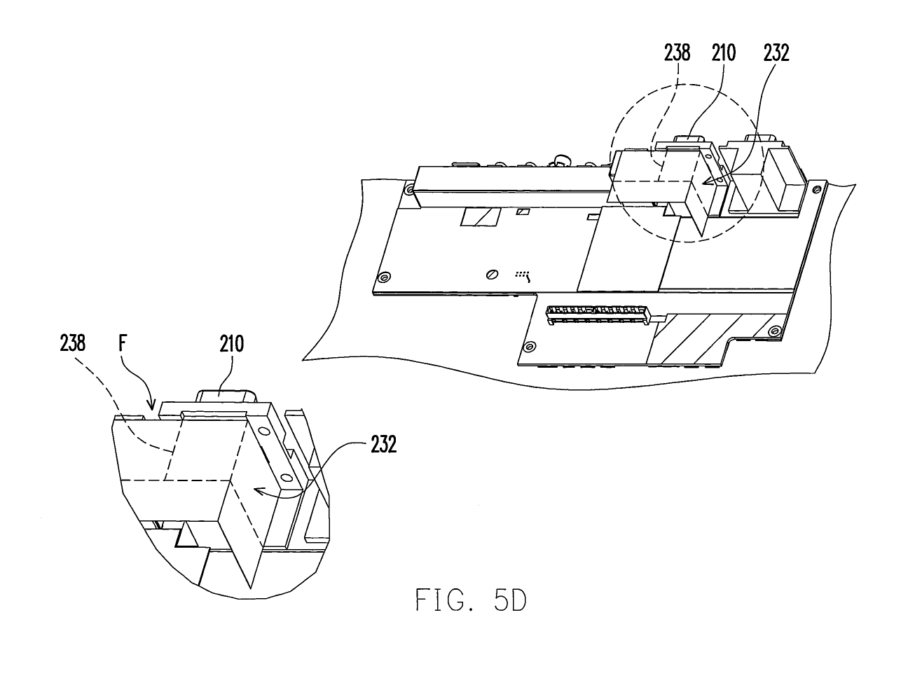

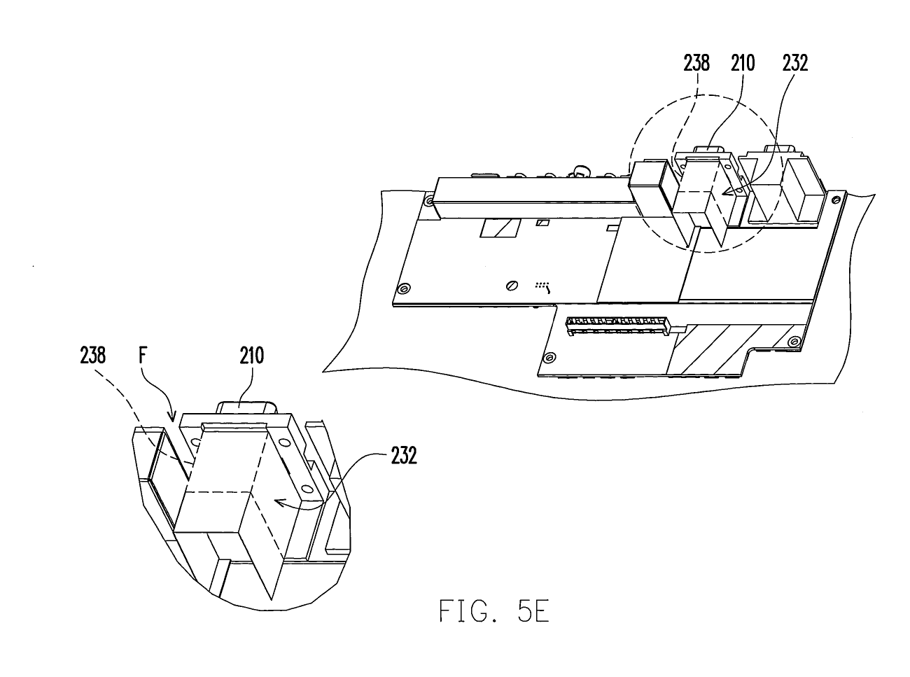

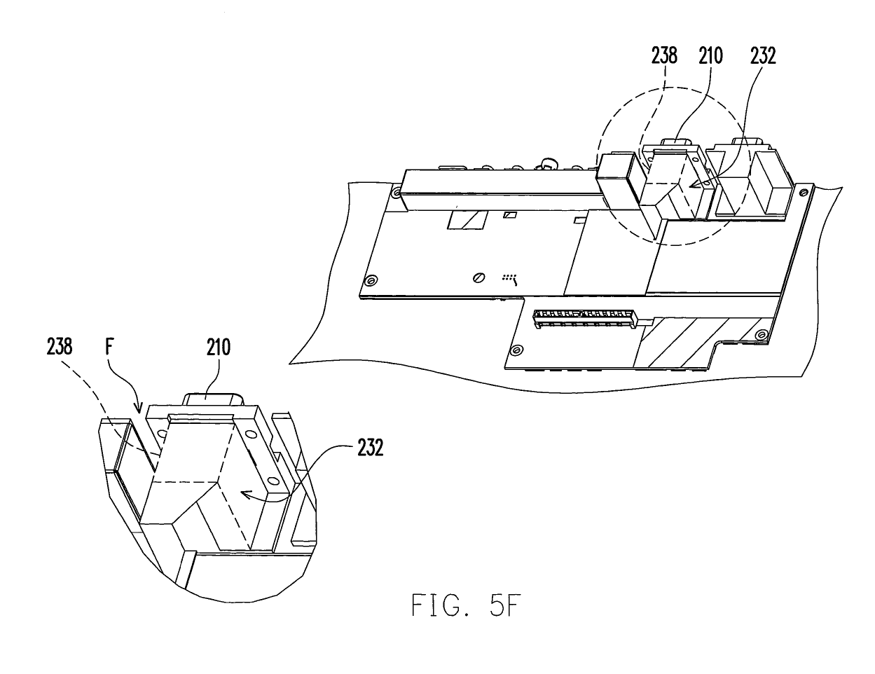

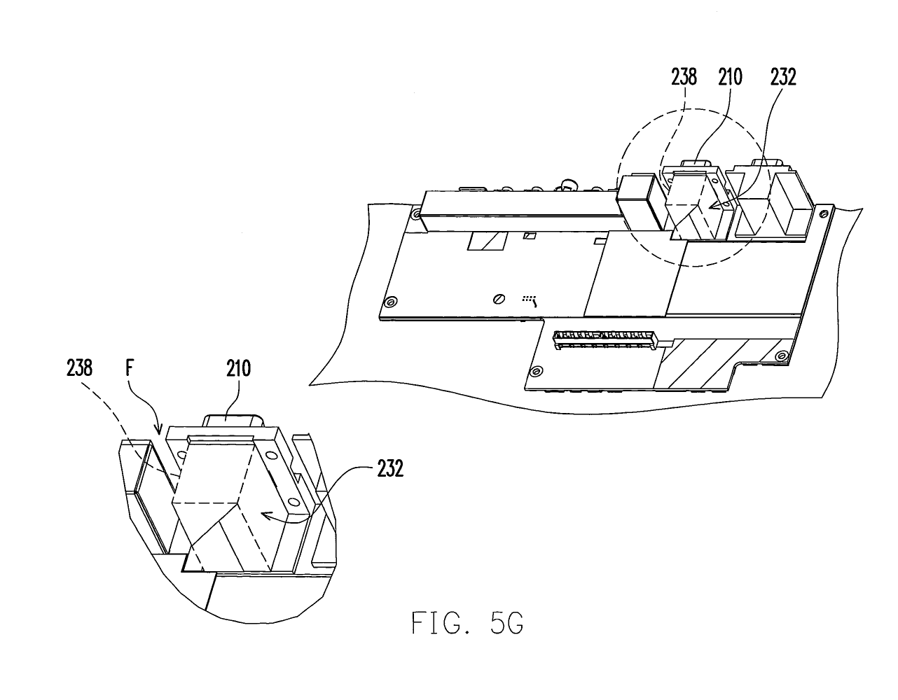

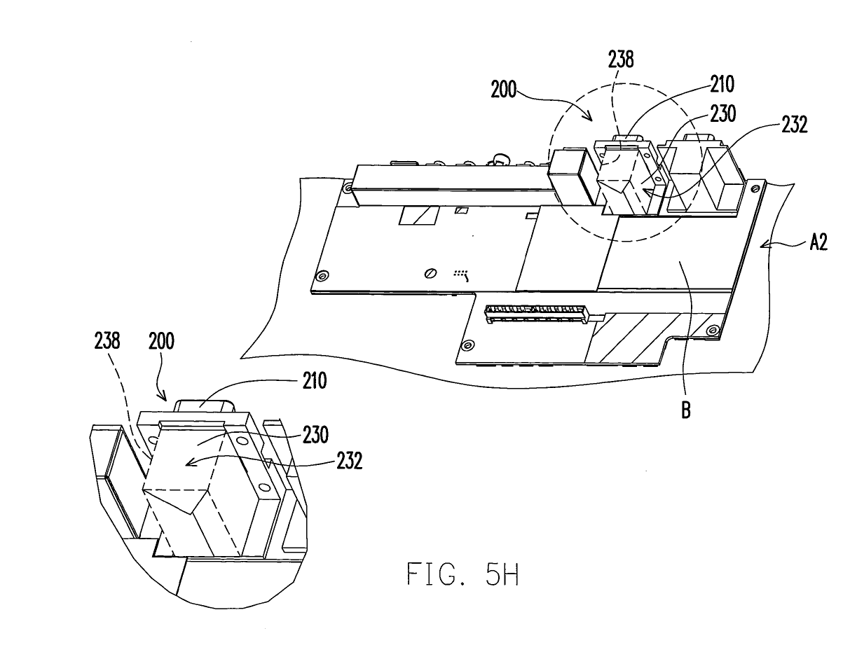

FIGS. 5A-5H are schematic views of the steps of assembling the aluminum-foil cover 230 onto the transmission part 220. Firstly, referring to FIG. 5A, an aluminum-foil plate F is provided, which comprises a first surface 232, a second surface 234, and a glue 236. The first surface 232 and the second surface 234 are opposite to each other and the glue 236 is disposed on the second surface 234. In the present embodiment, the thickness d2 of the aluminum-foil plate F is smaller than or equal to 0.1 mm, and the aluminum-foil plate F comprises at least one auxiliary line 238 (three shown in FIG. 5A), which is disposed on the first surface 232 of the aluminum-foil plate F.

Next, referring to FIG. 5B, a plurality of connection ports 210 and a transmission part 220 are provided, wherein the transmission part 220 is electrically connected to the connection ports 210. In the present embodiment, the transmission part 220 is disposed on the circuit board B in advance and electrically connected to the circuit board B. It should be noted that, upon designers' requirements, the following steps can also be performed without the step of disposing the transmission part 220 onto the circuit board B in advance.

Then, referring to FIG. 5C, one of the auxiliary lines 238 is correspondingly aligned with one of the plurality of edges 224 of the transmission part 220. Subsequently, a part of the aluminum-foil plate F is stuck on a part of the surface 222 of the transmission part 220 through the glue 236.

Then, referring to FIGS. 5C-5H, other parts of the aluminum-foil plate F are sequentially buckled along the edges 224 of the transmission part 220 and closely stuck onto other parts of the surface 222 of the transmission part 220 through the glue 236 by means of pressurization, so as to form the aluminum-foil cover 230 which covers the transmission part 220. It should be noted that the present embodiment does not intend to limit the manner of sticking the aluminum-foil plate F onto the surface 222 of the transmission part 220, and the aluminum-foil plate F can be stuck from any part of the surface 222 of the transmission part 220, as long as the aluminum-foil plate F can form the aluminum-foil cover 230 which covers the transmission part 220.

In view of the above, the connector of the present invention has at least one or more of the following advantages.

1. Since the aluminum-foil cover of the present invention is shaped in advance through buckling the aluminum-foil plate and sticking it onto the surface of the transmission part, instead of undergoing the process of machining, the manufacturing method of the aluminum-foil cover disclosed by the present invention is simple and the manufacturing cost is low.

2. After the aluminum-foil cover disclosed by the present invention is employed, since the aluminum-foil cover has preferable EMI-shielding function, the video signal transmitted by the connection port has less noise, the frame shown by the video signal have less irregular bright spots.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A connector, suitable for an electronic apparatus, comprising:
a plurality of connection ports;
a transmission part, electrically connected to the connection ports; and
an aluminum-foil cover, comprising a first surface, a second surface, and glue, wherein the first surface and the second surface are opposite to each other, the second surface faces towards the transmission part, the glue is disposed on the second surface, and the aluminum-foil cover is stuck on the surface of the transmission part by means of the glue, the aluminum-foil cover covers the transmission part.

2. The connector as claimed in claim 1, wherein the aluminum-foil cover comprises at least one auxiliary line, which is disposed on the first surface and correspondingly aligned with one of a plurality of edges of the transmission part.

3. The connector as claimed in claim 1, wherein the connection ports are video graphics array connection ports.

4. The connector as claimed in claim 1, wherein the aluminum-foil cover comprises an aluminum-foil plate with the thickness smaller than or equal to 0.1 mm.

5. The connector as claimed in claim 1, wherein the aluminum-foil cover comprises an aluminum-foil plate, which is buckled along a plurality of edges of the transmission part to be stuck on the surface of the transmission part, so as to form the aluminum-foil cover.

6. The connector as claimed in claim 1, wherein the transmission part is electrically connected to a circuit board.
